(19) United States
(12) Patent Application Publication
(10) Pub. No.: US 2016/0356181 A1
(43) Pub. Date: Dec. 8, 2016

(54) ANTI-ROTATION STRUCTURES FOR TURBOCHARGER HOUSINGS

(71) Applicant: BorgWarner Inc., Auburn Hills, MI (US)

(72) Inventors: Aliihsan Karamavruc, Fletcher, NC (US); Robert M. Dysert, Asheville, NC (US); Roland Roth, Arden, NC (US)

(21) Appl. No.: 14/730,916

(22) Filed: Jun. 4, 2015

(51) Int. Cl. F01D 25/24

(52) U.S. Cl. CPC F01D 25/243; F05D 2220/40

(57) ABSTRACT

A turbocharger includes a first housing having a first annular surface and a second housing having a second annular surface. A projection defined integrally on the first annular surface. A recess is formed integrally on the second annular surface. The projection is disposed in the recess and engagement of the projection with the recess restrains rotation of the first housing with respect to the second housing.

### BACKGROUND

In the field of internal combustion engines, turbochargers are forced-induction devices that are utilized to increase the pressure of the intake air provided to the engine. By pressurizing the intake air, the amount of air and fuel that can be forced into each cylinder during an intake stroke of the engine is increased. This produces an increased power output relative to a naturally-aspirated engine.

A typical turbocharger includes a multi-part housing. For example, the housing of a turbocharger can include a bearing housing, a turbine housing that is connected to the bearing housing, and a compressor housing that is connected to the bearing housing.

A turbine wheel is located in the turbine housing. Exhaust gases enter the turbine housing and cause the turbine wheel to rotate. A compressor wheel is located in the compressor housing. The compressor wheel is connected to the turbine wheel by a shaft. When the turbine wheel spins, the compressor wheel also spins, which pressurizes intake air that is then routed to the engine. The shaft is supported in the bearing housing such that it is able to rotate freely with respect to the bearing housing at a very high rotational speed.

The turbine housing and bearing housing can be connected by a clamp or a similar mechanism. One common clamp that is used for this purpose is a v-band clamp that engages lips or similar structures that are defined on the bearing housing and the turbine housing. The clamping force provided by the v-band clamp resists axial movement of the turbine housing with respect to the bearing housing and also resists rotation of the turbine housing with respect to the bearing housing. Under certain conditions, however, high torsional loads can overcome the force applied by the v-band clamp and cause rotation of the turbine housing with respect to the bearing housing.

### SUMMARY

One aspect of the disclosed embodiments is a turbocharger that includes a first housing having a first annular surface and a second housing having a second annular surface. A tooth defined integrally on first annular surface. A recess is formed integrally the second annular surface. The tooth is disposed in the recess and engagement of the tooth with the recess restrains rotation of the first housing with respect to the second housing.

Another aspect of the disclosed embodiments is a turbocharger that includes a turbine housing, a bearing housing, a first flange disposed on the turbine housing, a second flange disposed on the bearing housing, and a v-band clamp that is secured to the first flange of the turbine housing and to the second flange of the bearing housing. A first annular surface is defined on the turbine housing. A second annular surface is defined on the bearing housing. A projection is defined integrally on one of the first annular surface or the second annular surface. A recess is formed integrally on the other of the first annular surface or the second annular surface, wherein the projection is disposed in the recess and engagement of the projection with the recess restrains rotation of the turbine housing with respect to the bearing housing.

Another aspect of the disclosed embodiments is a turbocharger that includes a turbine housing, a bearing housing, a first flange disposed on the turbine housing, a second flange disposed on the bearing housing, and a v-band clamp that is secured to the first flange of the turbine housing and to the second flange of the bearing housing. A first annular surface is defined on the turbine housing and first plurality of recesses is formed in the first annular surface. A second annular surface is defined on the bearing housing and a second plurality of recesses formed in the second annular surface. A heat shield is disposed between the first annular surface and the second annular surface. A plurality of projections are formed on the heat shield, each projection having a first end that is disposed in one of the recesses from the first plurality of recesses, and each projection having a second end that is disposed in one of the recesses from the second plurality of recesses. Engagement of the projections with the first plurality of recesses and the second plurality of recesses restrains rotation of the turbine housing with respect to the bearing housing.

### BRIEF DESCRIPTION OF THE DRAWINGS

The description herein makes reference to the accompanying drawings, wherein like referenced numerals refer to like parts throughout several views, and wherein:

FIG. 1 is a perspective view showing portions of a turbine housing and a bearing housing of a first implementation;

FIG. 2 is a perspective detail view of the turbine housing and the bearing housing of the first implementation;

FIG. 3 is a cross-section view of the turbine housing and the bearing housing of the first implementation;

FIG. 4 is a perspective detail view of a turbine housing and a bearing housing of a second implementation;

FIG. 5 is a cross-section view of a turbine housing and a bearing housing of a third implementation;

FIG. 6 is a cross-section view of a turbine housing and a bearing housing of a fourth implementation; and

FIG. 7 is a cross-section view of a turbine housing, a bearing housing, and a heat shield of a fifth implementation.

### DETAILED DESCRIPTION

The disclosure herein is directed turbocharger housings that incorporate anti-rotation features. The anti-rotation features can be provided at the interface of two housing portions of the turbocharger, such as at the interface of the turbine housing and the bearing housing.

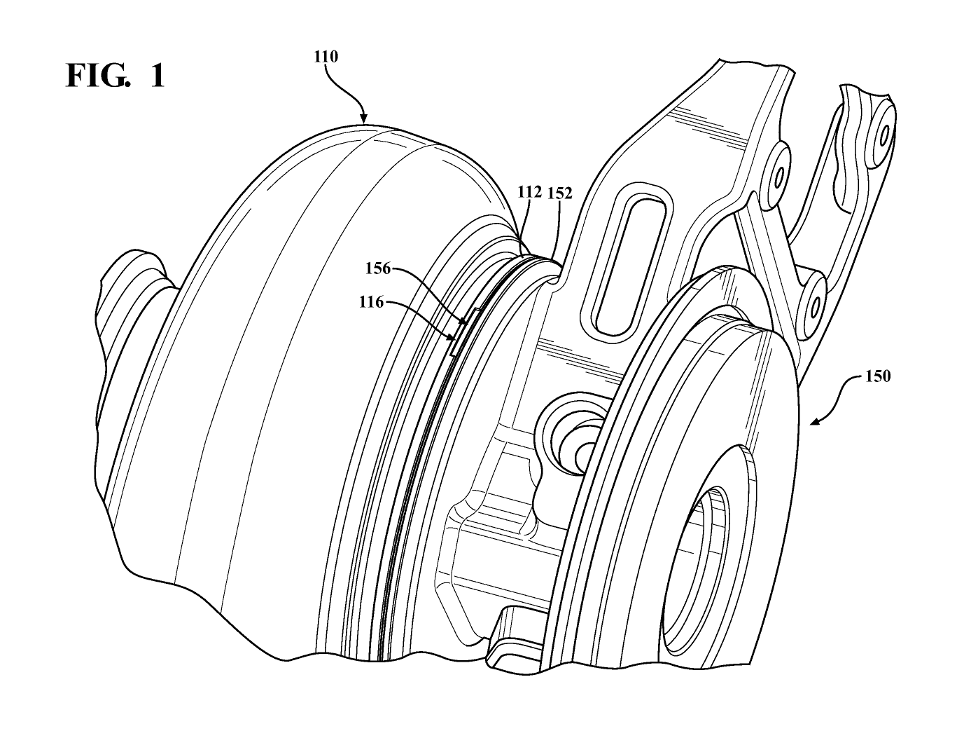

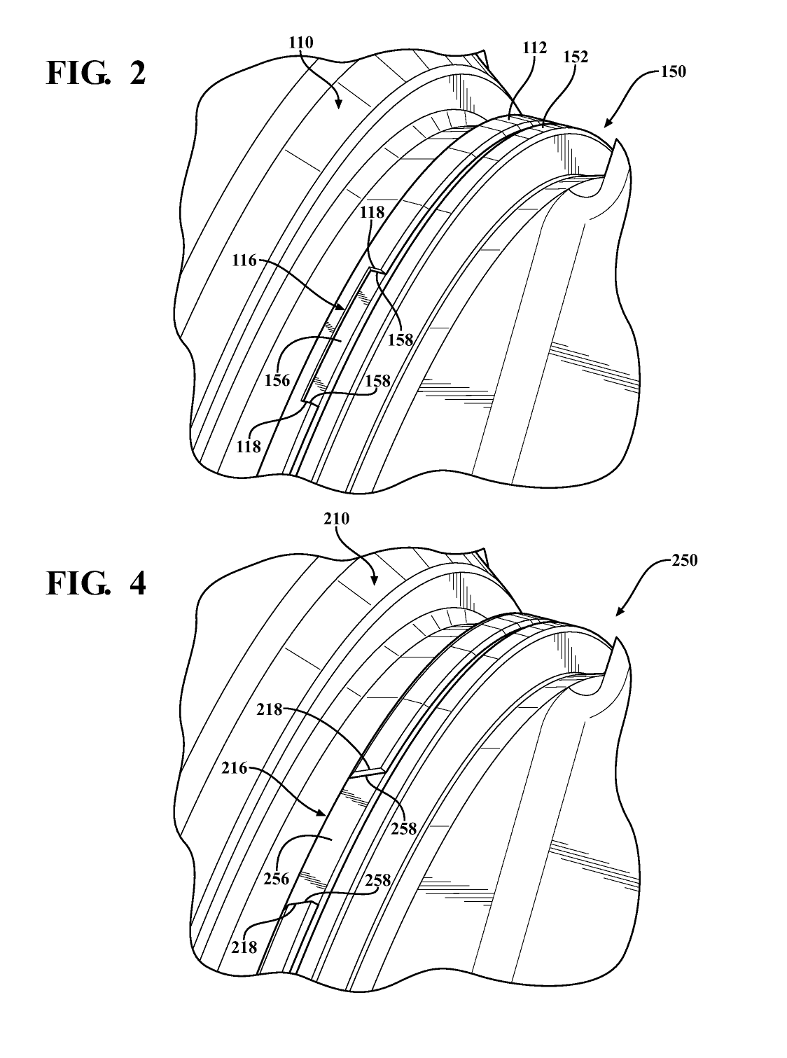

FIGS. 1-3 show portions of a turbine housing 110 and a bearing housing 150 of a turbocharger according to a first implementation. The turbine housing 110 and the bearing housing 150 are described herein as examples a first housing and a second housing that can be connected to one another. Persons of skill in the art will recognize that the teachings described herein can be applied to other types of housings.

The turbine housing 110 and the bearing housing 150 each include a plurality of annular structures and surfaces that are arranged around an axis, such as the axis of rotation of a turbocharger shaft. In order to connect the turbine housing 110 and the bearing housing 150, the turbine housing 110 includes a first flange 112 and the bearing housing 150 includes a second flange 152. The first flange 112 and the second flange 152 are annular structures that are formed on the exterior of the turbine housing 110 and the bearing housing 150, respectively, to provide surfaces that are engageable with a connecting structure such as a clamp.

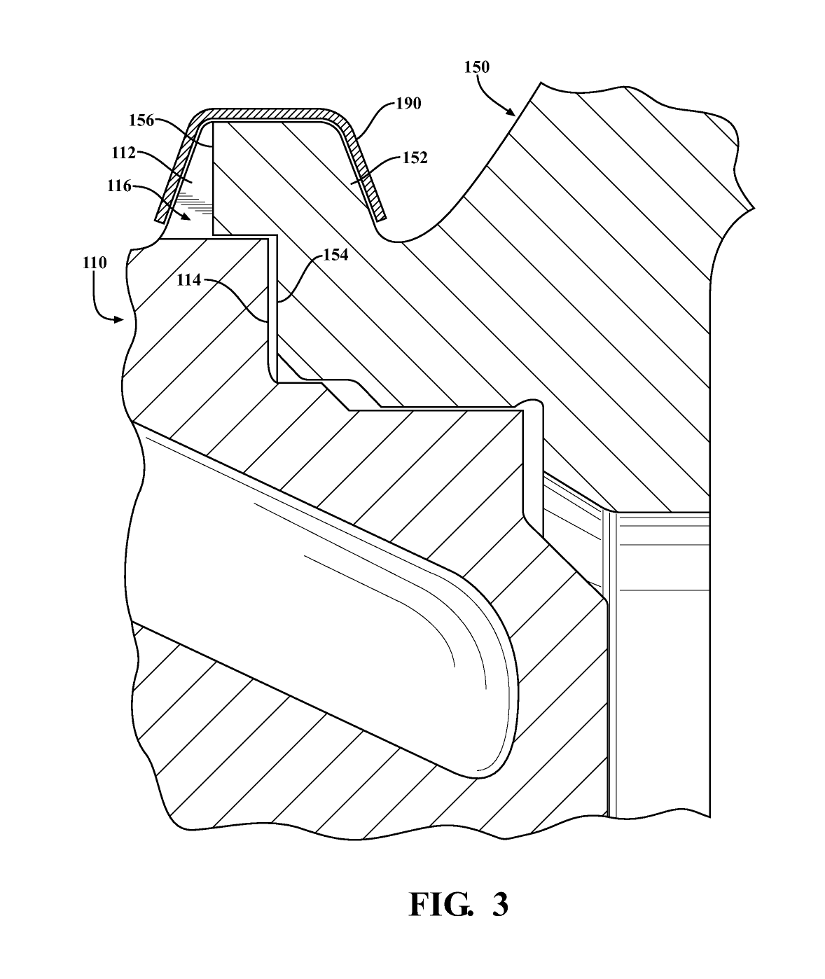

In the illustrated example, a v-band clamp 190 (FIG. 3) extends circumferentially around the first flange 112 of the turbine housing 110 and the second flange 152 of the bearing housing 150. The v-band clamp 90 is convention, and can include a mechanism (not shown) that allows the v-band clamp 90 to be engaged and released, by decreasing and increasing, respectively, the circumference of the v-band clamp 90. The v-band clamp 190 engages and is secured to both the first flange 112 and the second flange 152 in order to restrain the turbine housing 110 from separating axially from the bearing housing 150. Engagement of the v-band clamp 90 also provides some resistance to rotation of the turbine housing 110 with respect to the bearing housing 150.

The turbine housing 110 and the bearing housing 150 including multiple pairs of corresponding annular surfaces, including surfaces that face one another and/or are engaged with one another. Some pairs of corresponding annular surfaces face one another by being oriented in opposing axial directions. Other pairs of corresponding annular surfaces face one another by being oriented in opposing radial direction, where radial is defined as a direction that extends from or toward the axis around which a particular annular surface is defined. In the illustrated example of FIGS. 1-3, for instance, the turbine housing 110 includes a first annular surface 114 and the bearing housing includes a second annular surface 154. The first annular surface 114 is formed on the first flange 112 of the turbine housing 110 and is oriented in a first axial direction such that it faces the second flange 152 of the bearing housing 150. The second annular surface 154 is formed on the second flange 152 of the bearing housing 150 and is oriented in a second axial direction, which is opposite the first axial direction, such that it faces the first flange 112 of the turbine housing 110. Thus, the first annular surface 114 faces the second annular surface 154. The first annular surface 114 and second annular surface 154 can be adjacent to and/or extend to the outer peripheries of the first flange 112 and the second flange 152, respectively.

In order to retrain rotation of the turbine housing 110 with respect to the bearing housing 150, the turbine housing 110 and the bearing housing 150 each include structures that cooperate to define one or more anti-rotation features. In the illustrated example, the turbine housing 110 includes a recess 116 that is formed integrally on the first annular surface 114 of the turbine housing, and the bearing housing 150 includes a projection 156 that is formed integrally on the second annular surface 154. Together, the recess 116 and the projection 156 define an anti-rotation feature.

In addition to the anti-rotation feature defined by the recess 116 and the projection 156, other identical or similar anti-rotation features can also be provided on the turbine housing 110 and the bearing housing 150 at spaced locations around the first flange 112 and the second flange 152. For example, the turbine housing 110 and the bearing housing 150 can include two or pairs of the recess 116 and the projection 156, which can define an array circumferentially around the first flange 112 and the second flange 152. In addition, it should be understood that the recess 116 can be provided on either of the first flange 112 of the turbine housing 110 or the second flange 152 of the bearing housing 150, and the projection 156 would then be provided on the other of the first flange 112 of the turbine housing 110 or the second flange 152 of the bearing housing 150.

In the illustrated embodiment, the recess 116 is a cutout that is integrally formed in the first flange 112. The recess 116 extends inward from the outer periphery of the first flange 112 by a consistent depth. A first pair of end surfaces 118 of the recess 116 are spaced circumferentially from one another, each extending in the axial direction of the turbine housing 110. Similarly, the projection 156 is integrally formed on the second flange 152 as an extension of the second flange 152 in the axial direction outward from the nominal position of the second annular surface 154 of the second flange 152. The projection 156 is complementarily shaped relative to the recess 116, such that engagement of the projection 156 with the recess 116 is operable to restrain rotation of the turbine housing 110 with respect to the bearing housing 150. Accordingly, the projection 156 extends inward from the outer periphery of the second flange 152 by a consistent depth, and a second pair of end surfaces 158 of the projection 156 are spaced circumferentially from one another, each extending in the axial direction of the bearing housing 150.

In the illustrated example, the recess 116 and the projection 156 are formed on external surfaces of the turbine housing 110 and the bearing housing 150 such that they are exposed when the turbine housing 110 is connected to the bearing housing 150. It should be understood, however, that the recess 116 and the projection 156 could be formed on or as internal surfaces of the turbine housing and the bearing housing, such that they are not exposed to the exterior when the turbine housing 110 is connected to the bearing housing 150.

It should be understood that other geometric configurations can be utilized for the recess 116 and the projection 156. For example, in alternative implementations, the projection can be at least one of rectangular, round, or v-shaped, and the recess is formed complementarily to the projection.

In use, the turbine housing 110 is assembled to the bearing housing 150 such that the projection 156 of the bearing housing 150 is disposed in the recess 116 of the turbine housing 110. The v-band clamp 190 is then engaged with the first flange 112 of the turbine housing 110 and the second flange 152 of the bearing housing 150 and tightened to restrain the turbine housing from moving axially with respect to the bearing housing 150, which also prevents the projection 156 from exiting and thereby disengaging the recess 116. In response to a torsional load applied to one of the turbine housing 110 or the bearing housing 150, engagement of the first pair of end surfaces 118 of the recess 116 with the second pair of end surfaces 158 of the projection 156 restrains rotation of the turbine housing 110 with respect to the bearing housing 150.

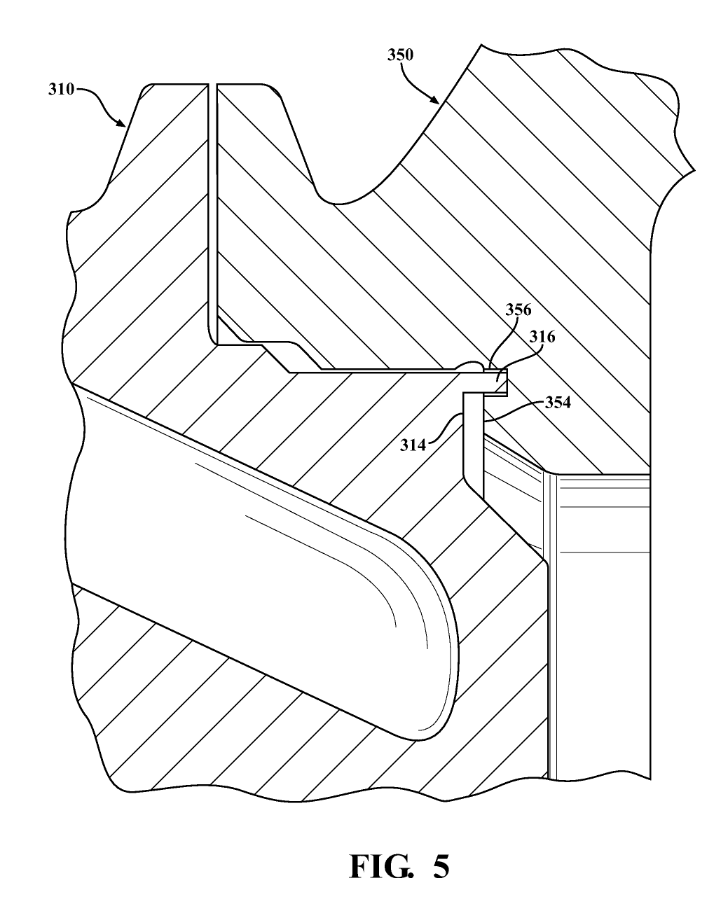

FIG. 4 shows a second implementation in which a turbine housing 210 and a bearing housing 250 and their constituent parts are similar to the turbine housing 110 and the bearing housing 150 except as described herein.

The turbine housing 210 includes a recess 216 and the bearing housing 150 includes a projection 256. The recess 216 and the projection 256 differ from the recess 116 and the projection 256 by their end surfaces. In particular, the recess 216 has a first pair of angled end surfaces 218 and the projection 256 has a second pair of angled end surfaces 258 that are complementary, with the surfaces being angled relative to the axial direction. As a result, resistance to rotation is increased in a single rotational direction. Also, assembly and disassembly of the turbine housing 210 with respect to the bearing housing 250 involves slight rotation of the bearing housing 250 with respect to the turbine housing 210 as they are moved axially together or apart. Use of the turbine housing 210 and the bearing housing 250 is as described with respect to the turbine housing 110 and the bearing housing 150.

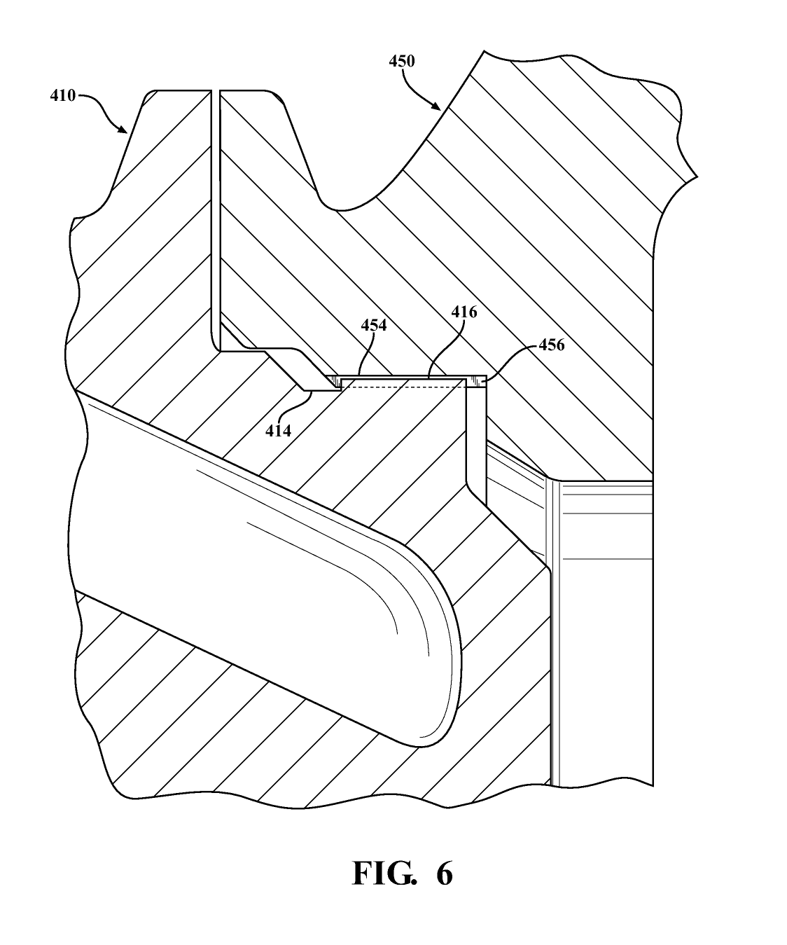

FIG. 5 shows a third implementation in which a turbine housing 310 and a bearing housing 350 and their constituent parts are similar to the turbine housing 110 and the bearing housing 150 except as described herein.

The turbine housing 310 includes an interior annular surface 314, with a projection 316 formed integrally on the interior annular surface 314. In the illustrated example, the projection is a peripherally-extending member of constant axial depth and constant radial height. Other geometries could be used as noted with respect to the projection 156.

The bearing housing 350 includes an interior annular surface 354, with a recess 356 formed integrally on the interior annular surface 354. The recess 356 is configured complementary to the recess 116, and is therefore engageable with the projection 316 to restrain rotation of the turbine housing 310 with respect to the bearing housing 350 in the same manner previously described.

FIG. 6 shows a fourth implementation in which a turbine housing 410 and a bearing housing 350 and their constituent parts are similar to the turbine housing 110 and the bearing housing 150 except as described herein.

The turbine housing 410 and the bearing housing 450 have opposed, radially oriented surfaces on which anti-rotation features are defined, namely an interior annular surface 414 of the turbine housing 410 and an interior annular surface 454 of the bearing housing 450. Since they are defined on radial faces, the anti-rotation features extend axially. In particular, turbine housing 410 includes an axially extending projection 416, which can be for example, a tooth or a spline. The bearing housing 450 includes an axially-extending recess 456, which can be for example, a tooth or a spline. In the cases of structures such as teeth or splines, these structures can be arrayed on the interior annular surface 414 and the interior annular surface 454, either at intervals or continuously. The recess 456 is engageable with the projection 416 to restrain rotation of the turbine housing 410 with respect to the bearing housing 450 in the same manner previously described.

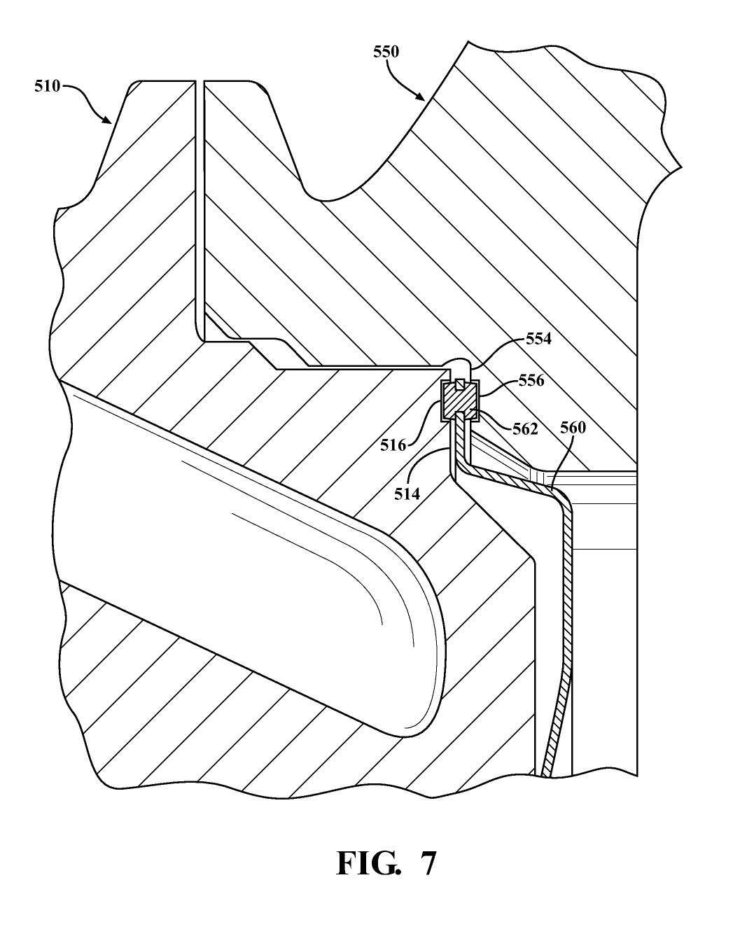

FIG. 7 shows a fifth implementation in which a turbine housing 510 and a bearing housing 550 and their constituent parts are similar to the turbine housing 110 and the bearing housing 150 except as described herein.

The turbine housing 510 and the bearing housing 550 have opposed, internal, axially-facing surfaces, namely a first internal annular surface 514 and a second internal annular surface 554 on which are formed a first recess 516 and a second recess 556. The first recess 516 and the second recess 518 extend over a limited circumferentially distance and can be, as examples, cylindrical recesses or arc-shaped recesses. A heat shield 560 is interposed between the first internal annular surface 514 and the second internal annular surface 554, and is adapted to reduce heat transfer from the turbine housing 510 to the bearing housing 550. One or more projections 562 are formed on or connected to the heat shield 560. In one implementation, a single projection 562 is provided. In other implementations, multiple projections 562 are provided in an annular array around the heat shield 560, with corresponding recesses also provided. The projection 562 extends axially into both of the first recess 516 and the second recess 556. Engagement of the projection 562 with the first recess 516 and the second recess 556 restrains rotation of the turbine housing 510 with respect to the bearing housing 550 as similarly described with respect to the turbine housing 110 and the bearing housing 150.

While the disclosure has been made in connection with what is presently considered to be the most practical and preferred embodiment, it should be understood that the disclosure is intended to cover various modifications and equivalent arrangements.

1. A turbocharger, comprising:
a first housing having a first annular surface oriented in a first axial direction;
a second housing having a second annular surface oriented in a second axial direction opposing the first axial direction;
a projection defined integrally on the first annular surface; and
a recess formed integrally on the second annular surface,
wherein the projection is disposed in the recess and engagement of the projection with the recess restrains axial rotation of the first housing with respect to the second housing, and
wherein the recess and the projection include circumferentially-spaced and complementary first and second end surfaces angled with respect to the axial direction and increasing resistance to axial rotation in a single rotational direction.

2. The turbocharger of claim 1, further comprising:
a first flange disposed on the first housing, wherein the first annular surface is on the first flange; and
a second flange disposed on the second housing, wherein the second annular surface is on the second flange.

3. The turbocharger of claim 2, further comprising:
a v-band clamp that is secured to the first flange of the first housing and to the second flange of the second housing.

4. The turbocharger of claim 1, wherein the first annular surface is an internal surface of the first housing and the second annular surface is an internal surface of the second housing.

5-10. (canceled)

11. A turbocharger, comprising:
a turbine housing;
a bearing housing;
a first flange disposed on the turbine housing;
a second flange disposed on the bearing housing;
a v-band clamp that is secured to the first flange of the turbine housing and to the second flange of the bearing housing;
a first annular surface defined on the turbine housing and oriented in a first axial direction;
a second annular surface defined on the bearing housing and oriented in a second axial direction opposite the first axial direction;
a projection defined integrally on one of the first annular surface or the second annular surface; and
a recess formed integrally on the other of the first annular surface or the second annular surface,
wherein the projection is disposed in the recess and engagement of the projection with the recess restrains axial rotation of the turbine housing with respect to the bearing housing, and
wherein the recess and the projection include circumferentially-spaced and complementary first and second end surfaces angled with respect to the axial direction and increasing resistance to axial rotation in a single rotational direction.

12. The turbocharger of claim 11, wherein the first annular surface is on the first flange and the second annular surface is on the second flange.

13. The turbocharger of claim 11, wherein the first annular surface is an internal surface of the turbine housing and the second annular surface is an internal surface of the bearing housing.

14-19. (canceled)

20. A turbocharger, comprising:
a turbine housing;
a bearing housing;
a first flange disposed on the turbine housing;
a second flange disposed on the bearing housing;
a v-band clamp that is secured to the first flange of the turbine housing and to the second flange of the bearing housing;
a first annular surface defined on the turbine housing and oriented in a first axial direction;
a first plurality of recesses formed in the first annular surface;
a second annular surface defined on the bearing housing and oriented in a second axial direction opposite the first axial direction;
a second plurality of recesses formed in the second annular surface;
a heat shield that is disposed between the first annular surface and the second annular surface; and
a plurality of projections that are formed on the heat shield, each projection having a first end that is disposed in one of the recesses from the first plurality of recesses, and each projection having a second end that is disposed in one of the recesses from the second plurality of recesses such that engagement of the projections with the first plurality of recesses and the second plurality of recesses restrains rotation of the turbine housing with respect to the bearing housing.
